(19) United States
(12) Patent Application Publication
(10) Pub. No.: US 2003/0017746 A1
(43) Pub. Date: Jan. 23, 2003

(54) Adaptor to connect handheld computing devices to peripheral devices

(75) Inventor: Yin-Hsien Lee, Taipei (TW)

Correspondence Address: BACON & THOMAS, PLLC, 625 SLATERS LANE, FOURTH FLOOR, ALEXANDRIA, VA, 22314

(73) Assignee: DATAplus Supplies, Inc., Taipei (TW)

(21) Appl. No.: 09/903,536

(22) Filed: Jul. 13, 2001

(51) Int. Cl. H01R 25/00

(52) U.S. Cl. 439/638

(57) ABSTRACT

An adaptor to connect handheld computing devices to peripheral devices and to provide connectivity between various versions of handheld computing devices, such as the Palm PDA and peripheral devices. The top end of the adaptor has a first inserting connector, which is connected to the handheld computing device via an insertion slot, and the bottom end of the adaptor has a second inserting connector, which is connected to the connection interface of the peripheral device. Thus, the adaptor of the present invention can connect a peripheral device to various types of handheld computing devices, which may have a different interface connection.

### ABSTRACT OF PRESENT INVENTION

The present invention is regarding to an adaptor to connect handheld computing devices to peripheral devices providing connectivity between various version of handheld computing devices, such as Palm PDA, and peripheral devices. The top end of the adaptor having a first inserting connector, which could be connected to the handheld computing device, and the bottom end of the adaptor having a second inserting connector, which could be connected to the peripheral device. While using this adaptor, inserting the first inserting connector of the adaptor into the inserting slot of the handheld computing device, then inserting the second inserting connector of the adaptor into the connection interface of the peripheral device. Thus, using the adaptor of the present invention can connect a peripheral device to various types of handheld computing devices, which may be having different connection interface, and without unmatched connection problem.

1. Background of Present Invention

The present invention is regarding to an adaptor used as a connecting device for connecting to handheld computing devices and peripheral devices. The adaptor can connect a peripheral device to various types of handheld computing devices, which may be having different connection interface. Therefore, a peripheral device may be connected to any types of handheld computing device by using a proper adaptor and without a limit of different connection interface. Thus, the present invention could be reduced the cost of peripheral devices that suppliers do not need to provide different types of certain peripheral device with different connection interfaces in order to match the handheld computing devices, respectively.

2. Prior Art

In general, handheld computing devices or palm personal digital assistants are portable, lightweight and small. Unlike the desktop computer, there are few of compatible peripheral devices could be used to handheld computing devices. Thus, functions and operations of handheld computing devices will be limited, for instance, the handheld computing device text or data entry will often rely on the use of a stylus instead of a keyboard. However, the speed of input text by handwriting is much slow than typing a keyboard. Therefore, there is a foldable keyboard is provided to be an alternative key in device for the handheld computing device. With reference to FIG. 1, in the back of the foldable keyboard 100 having an opening space (not shown); the opening space comprises a docking connector support bracket 110; the support bracket 110 comprises a support leg 111; at end of the support leg 111 pivotally connects a flat support 112; at other end of the flat support 112 pivotally connects a support easel 113; the other end of support easel 113 attaches the intersection of support leg 111 and flat support 112; at the end of the support easel 113 comprises a docking connector 114. To use the portable keyboard, slide the docking connector support bracket 110 out from opening space; then push the flat support 112 outward; Line up the Palm handheld 200 with the angle of the support bracket 110 and slide the Palm handheld 200 securely onto the portable keyboard docking connector 114; Lean the Palm handheld 200 on the support easel 113 and let users have a good view to use the Palm handheld 200. When finished using the portable keyboard 100, removing the Palm handheld 200 and fold the docking connector support bracket in and down flat; then slide it back into opening space of the keyboard. However, above-mentioned portable keyboard docking connector 114 is only compatible to Palm V series handheld. The Palm handheld of other series, such as Palm III, Palm VII and Palm m100, may not use this portable keyboard 100 due to an unmatched docking connector. It is will be increase cost to redesign a new docking connector of the portable keyboard to match all series Palm handheld and may be made an inconvenience to the portable keyboard user.

### SUMMARY OF PRESENT INVENTION

To solve above-mentioned problem of providing portable keyboard with different types of connection interface to connect various series of handheld computing devices, therefore, the present invention provides an adaptor which having a connector to connect to different types of connection interface of handheld devices.

It is an object of the present invention to provide a connecting device to connect to different types of connection interface of handheld computing devices and peripheral devices. It may not be limited that one shall use a peripheral device with proper docking connector to different series of handheld computing devices due to unmatched connection interfaces. It means that one can use a proper adaptor of the present invention to connect a peripheral device and most of the handheld computing devices with different types of connector, regardless their connection interfaces.

The adaptor to connect handheld computing devices to peripheral devices of the present invention comprising a first inserting connector, which can be connected to a handheld computing device and a second inserting connector, which can be connected to a peripheral device, wherein said first inserting connector may be changed its connector interface to match a handheld computing device with different type connection interface. While connecting the handheld computing device and the peripheral device, the handheld computing device is connected to the first inserting connector of the adaptor, and the peripheral device is connected to the second inserting connector of the adaptor.

Using the adaptor of the present invention can connect a peripheral device to various types of handheld computing devices with different types of connection interface, and without unmatched connection problems. Thus, it can reduce the cost of peripheral devices and be more convenient.

### BRIEF DESCRIPTION OF THE DRAWINGS

FIG. 1 shows an assembling view of a prior art.

FIG. 2 shows a rear view of an assembling embodiment according to the present invention.

FIG. 3 shows a front view of an assembling embodiment according to the present invention.

FIG. 4 shows an assembling embodiment according to the present invention incorporates the Palm handheld.

FIG. 5 shows an assembling embodiment according to the present invention incorporates the Palm handheld and a portable keyboard.

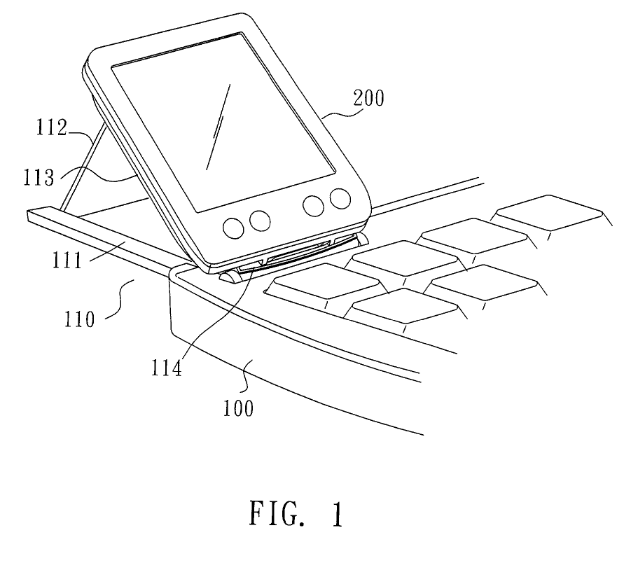

Reference numbers of main elements:

| | |
|---|---|
| Adaptor | 10 |
| First inserting connector | 12 |
| Second inserting connector | 13 |
| Palm handheld | 200 |
| Portable keyboard | 100 |

### DETAILED DESCRIPTION OF THE PREFERRED EMBODIMENT

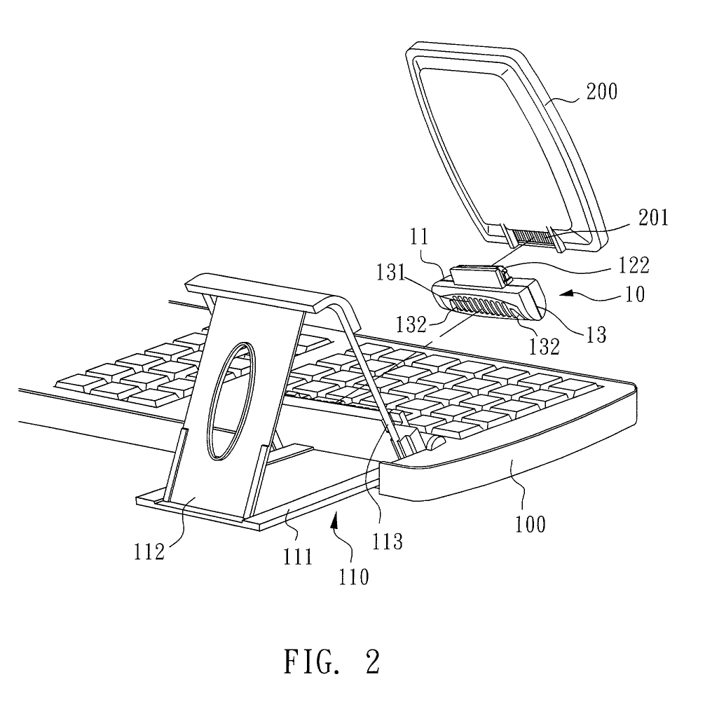

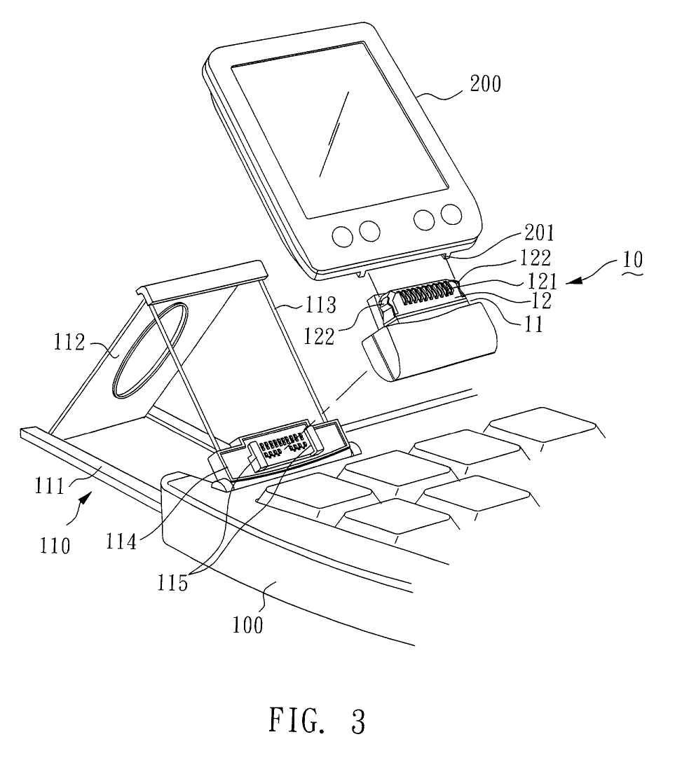

The present invention is regarding to an adaptor to connect handheld computing devices to peripheral devices. With reference to FIG. 2, 3, 4 and 5, the preferable embodiment, the adaptor 10 can be connected a portable keyboard to various series of Palm handheld 200 without limitation of different type of connection interface of various series of Palm handheld 200. With reference to FIGS. 2 and 3, the adaptor 10 of the present invention having a case 11, the case 11 having a printed circuit board (not shown), and top end of the case 11 having a first inserting connector 12, which could be coupled with inserting slot 201 of Palm handheld 200. The first inserting connector 12, with reference to FIG. 3, having a inserting contactor 121, and there are a pair of spring snap 122 on both side of said first inserting connector 12. On the opposing end of the case 11 having a second inserting connector 13, said second inserting connector 13 having an inserting contactor 131, and there are an intent on the both side of said second inserting connector, said indent guides the peripheral device into right position while the second inserting connector connecting to the peripheral device. The first inserting connector 12 and the second inserting connector 13 be coupled by a printed circuit board within the case 11, and thus electronic message can be transferred between the first inserting connector 12 and the second inserting connector 13 via the printed circuit board.

The adaptor 10 of the present invention can be inserting connected to a portable keyboard 100. The portable keyboard 100 having an opening space (not shown); the opening space comprises a support leg 111; at end of the support leg 111 pivotally connects a flat support 112; at other end of the flat support 112 pivotally connects a support easel 113; the other end of support easel 113 attaches the intersection of support leg 111 and flat support 112; at the end of the support easel 113 comprises a docking connector 114; at both end of the docking connector 114 have an ledge 115; the ledge 115 will clasp securely the slot 132 of the second inserting connector 13 of the adaptor 10 (shown as FIG. 2 and 3).

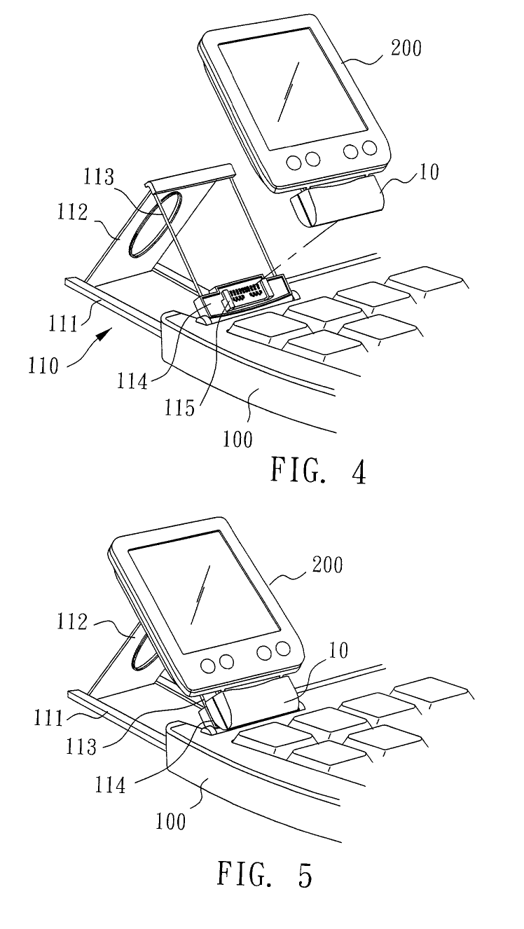

As using the adaptor of the present invention, with reference to FIG. 2, FIG. 3, FIG. 4 and FIG. 5, pulling out the back cover, above the inserting slot 201, from the Palm handheld 200, then, inserting the first inserting connector 12 of the adaptor 10 toward said inserting slot 201, and let the spring snap 122 of inserting connector 12 clasp both side of inserting slot 201 of palm handheld 200 and make sure the first inserting connector insert securely to the inserting slot 201 of the Palm handheld. Then, adjusting the angle between the docking connector 114 of the support bracket 110 and the portable keyboard 10 and inserting the second inserting connector 13 to the docking connector 114 of the portable keyboard 100 to connect the Palm handheld 200 and the portable keyboard 100.

Those skilled in the art will recognize that the foregoing description has been presented for the sake of illustration and description only. As such, it is not intended to be exhaustive or to limit the invention to the precise form disclosed. Modifications and variations are possible in light of the above teachings that are considered to be within the spirit of the present invention.

What the invention claimed is:

1. An adaptor to connect handheld computing devices to peripheral devices comprising, a first inserting connector, which can be connected to a handheld computing device;
a second inserting connector, which can be connected to a peripheral device;
wherein said first inserting connector may be changed its connector interface to match a handheld computing device with different type connection interface;
while connecting the handheld computing device and the peripheral device, the handheld computing device is connected to the first inserting connector of the adaptor, and the peripheral device is connected to the second inserting connector of the adaptor.

2. The adaptor to connect handheld computing devices to peripheral devices according to claim 1, wherein on the both side of said first inserting connector having a spring snap, said snaps clasp the side of inserting slot of the handheld computing device while the first inserting connector connecting to the handheld computing device.

3. The adaptor to connect handheld computing devices to peripheral devices according to claim 1, wherein on the both side of said second inserting connector having a indent, said indent guides the peripheral device into right position while the second inserting connector connecting to the peripheral device.
